(19) United States
(12) Patent Application Publication
(10) Pub. No.: US 2015/0330568 A1
(43) Pub. Date: Nov. 19, 2015

(54) Pressure Vessel Having Composite Boss With Weldable Metal Fitting

(71) Applicant: BLUE WAVE CO S.A., Luxembourg (LU)

(72) Inventors: Francesco NETTIS, London (GB); Brian SPENCER, Sacramento, CA (US); Zachary SPENCER, Sacramento, CA (US); Darrell HAWKINS, Newfoundland, Labrador (CA); Vanni Neri TOMASELLI, Luxembourg (LU)

(21) Appl. No.: 14/649,495

(22) PCT Filed: Dec. 5, 2012
(86) PCT No.: PCT/EP2012/074580

§ 371 Date: Jun. 3, 2015

(51) Int. Cl. F17C 1/02

(52) U.S. Cl. CPC F17C 1/02; F17C 2203/01; F17C 2203/0604; F17C 2203/0636

(57) ABSTRACT

This invention relates to a pressure vessel having a one-piece polymeric composite with a weldable metal fitting such that the pressure vessel can be coupled to a source of compressed fluid by a welded connection.

### FIELD

This invention relates to pressure vessels comprising a polymeric composite boss with a metal fitting suitable for welding to an external fluid source wherein the pressure vessels are used for the containment and transport of compressed fluids.

### BACKGROUND

The detrimental effects of the burning of fossil fuels on the environment are becoming more and more of a concern and have spurred great interest in alternative energy sources. While progress is being made with solar, wind, nuclear, geothermal, and other energy sources, it is quite clear that the widespread availability of economical alternate energy sources, in particular for high energy use applications, remains an elusive target. In the meantime, fossil fuels are forecast to dominate the energy market for the foreseeable future. Among the fossil fuels, natural gas is the cleanest burning and therefore the clear choice for energy production. There is, therefore, a movement afoot to supplement or supplant, as much as possible, other fossil fuels such as coal and petroleum with natural gas as the world becomes more conscious of the environmental repercussions of burning fossil fuels. Unfortunately, much of world's natural gas deposits exist in remote, difficult to access regions of the planet. Terrain and geopolitical factors render it extremely difficult to reliably and economically extract the natural gas from these regions. The use of pipelines and overland transport has been evaluated, in some instances attempted, and found to be uneconomical. Interestingly, a large portion of the earth's remote natural gas reserves is located in relatively close proximity to the oceans and other bodies of water having ready access to the oceans. Thus, marine transport of natural gas from the remote locations would appear to be an obvious solution. The problem with marine transport of natural gas lies largely in the economics. Ocean-going vessels can carry just so much laden weight and the cost of shipping by sea reflects this fact, the cost being calculated on the total weight being shipped, that is, the weight of the product plus the weight of the container vessel in which the product is being shipped. If the net weight of the product is low compared to the tare weight of the shipping container, the cost of shipping per unit mass of product becomes prohibitive. This is particularly true of the transport of compressed fluids, which conventionally are transported in steel cylinders that are extremely heavy compared to weight of contained fluid. This problem has been ameliorated somewhat by the advent of Type III and Type IV pressure vessels. Type III pressure vessels are comprised of a relatively thin metal liner that is wound with a filamentous composite wrap, which results in a vessel with the strength of a steel vessel at a substantial saving in overall vessel weight. Type IV pressure vessels comprise a polymeric liner that is likewise wrapped with a composite filamentous material. Type IV pressure vessels are the lightest of all the presently approved pressure vessels. The use of Type III and Type IV vessels coupled with the trend to make these vessels very large—cylindrical vessels 18 meters in length and 2.5-3.0 meters in diameter are currently being fabricated and vessel 30 or more meters in length and 6 or more meters in diameter are contemplated—has resulted in a major step forward in optimizing the economics of ocean transport of compressed fluids.

All pressure vessels require at least one end fitting, called a “boss,” by which the vessel is connected to external paraphernalia for loading fluids into and unloading fluids out of the vessel. Bosses in current use are made of metals such as stainless steel, nickel alloys, aluminum and the like. Unfortunately, these bosses, in particular with regard to the larger pressure vessels, are extremely heavy and have been estimated to comprise as much as 70% of the weight of a Type III or Type IV pressure vessel. Further, large metal bosses are difficult to manufacture and tend to be expensive, often costing $100,000 or more. These factors have a huge negative effect on the economics, and thereby the viability, of ocean transport of compressed fluids.

The above negative factors have been mitigated to a great extent by the advent of the one-piece composite boss as such is described in co-pending PCT application PCT/EP20/101810, filed on 5 Dec. 2011, which is incorporated by reference as if fully set forth herein. The composite boss described in the '810 application, however, depends on a nut-and-bolt assembly to connect the pressure vessel to an external source of a fluid with which the pressure vessel is to be loaded. With regard to the connection of a pressure vessel boss to an external fluid source, it is currently preferred in the shipping industry that the connection between the boss and the external fluid source be a metal-metal weld connection. A polymeric composite boss, however, is per se not amenable to welding to a metal fluid source. The present invention provides a composite boss modified to include a metal fitting that is capable of being welded to an external fluid source.

### SUMMARY

Thus, in one aspect, this invention relates to a pressure vessel comprising a one-piece polymeric composite boss and a one-piece weldable metal fitting coupled to the one-piece polymeric composite boss.

In an aspect of this invention, the one-piece polymeric composite boss comprises a proximal end that is external to the pressure vessel; a distal end that is internal to the pressure vessel; an inner surface that describes a central lumen in the shape of a truncated cone with its base at the distal end of the boss and its truncated apex at the proximal end of the boss; and

the one-piece weldable metal fitting comprises an outer surface that describes a truncated cone that is complementary to the truncated cone-shaped central lumen such that when the metal fitting is inserted into the lumen, the outer surface of the metal fitting is contiguous to the inner surface of the boss.

In an aspect of this invention, the pressure vessel further comprises a gasket shaped like a truncated cone, an outer surface of which is contiguous to the inner surface of the one-piece composite boss and an inner surface of which is contiguous to the outer surface of the one-piece metal fitting when the gasket is interposed between the inner surface of the one-piece composite boss and the outer surface of the metal fitting.

In an aspect of this invention, a length of the proximal end of the metal fitting extends outward from the proximal end of the composite boss.

In an aspect of this invention, the metal fitting further comprises a central cylindrical lumen.

In an aspect of this invention, the metal fitting further comprises a liner channel for receiving a portion of a pressure vessel liner.

In an aspect of this invention, a proximal end of the one-piece composite boss comprises an inset threaded groove and the one-piece metal fitting comprises a complementarily threaded annular ring that can be screwed into the threaded groove to couple the metal fitting to the boss.

In an aspect of this invention, before the threaded annular ring is screwed into the threaded groove of the composite boss, a gasket is fitted into the threaded groove of the composite boss such that an end of the threaded metal fitting contacts and compresses the gasket when the threaded metal fitting is tightened down into the threaded groove of the composite boss thereby forming a gas-tight seal.

### DETAILED DESCRIPTION

### BRIEF DESCRIPTION OF THE FIGURES

The figures are provided for illustrative purposes only and are not intended nor should they be construed as limiting this invention in any manner whatsoever.

FIG. 1 shows isometric projections of various types of pressure vessels. The vessels are shown with apertures where composite bosses modified with weldable metal fittings as set forth herein would be inserted.

FIG. 1A shows a spherical pressure vessel.

FIG. 1B shows and oblate spheroid, sometimes referred to as a “near sphere,” pressure vessel.

FIG. 1C shows a toroidal pressure vessel

FIG. 1D shows a pressure vessel with a cylindrical center section and one domed end section

FIG. 1E shows a pressure vessel with a cylindrical center section and two domed end sections.

FIG. 2 is a schematic representation of a pressure vessel with a cylindrical center section and two domed end sections.

FIG. 3 shows a one-piece polymeric composite boss, a one-piece weldable metal fitting and a coupled composite boss/metal fitting construct of this invention.

FIG. 4 shows the above composite boss/metal fitting construct coupled to a pressure vessel.

FIG. 5 shows an embodiment of this invention comprising a one-piece polymeric composite boss/one-piece weldable metal fitting construct coupled to a pressure vessel wherein a portion of a liner of the pressure vessel is inserted into a liner channel in the metal fitting to create a fluid-tight seal.

FIG. 6 shows an embodiment of this invention comprising a one-piece polymeric composite boss/one-piece weldable metal fitting construct wherein the boss and the fitting are designed such that the fitting can be screwed into the boss.

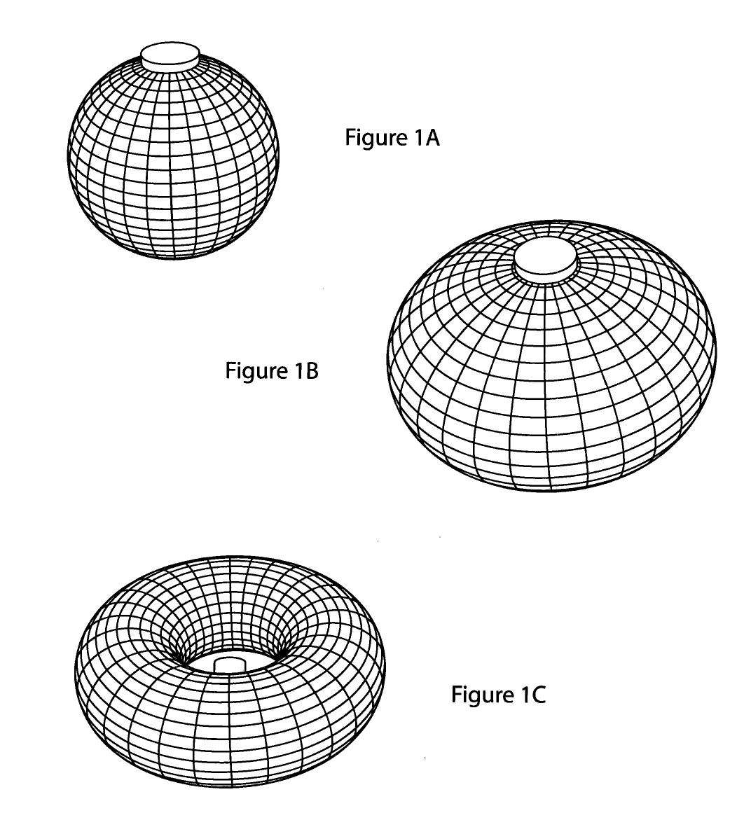

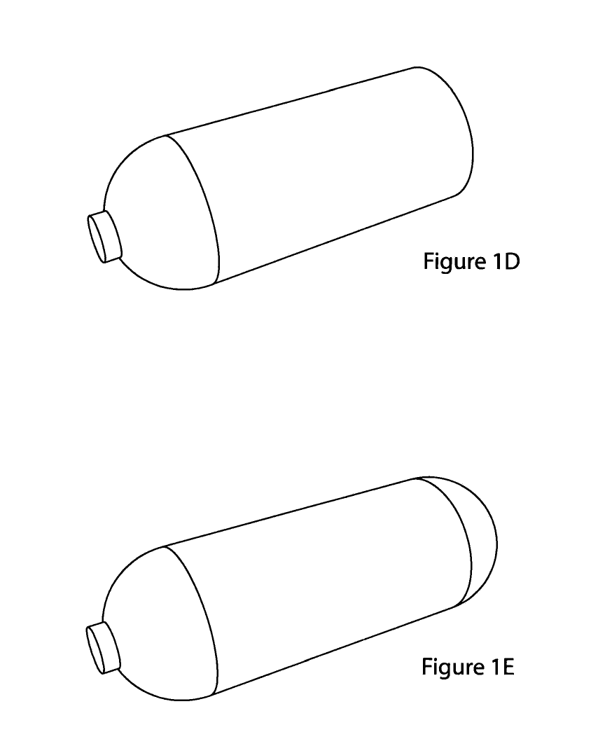

### DISCUSSION

It is understood that, with regard to this description and the appended claims, reference to any aspect of this invention made in the singular includes the plural and vice versa unless it is expressly stated or unambiguously clear from the context that such is not intended.

As used herein, any term of approximation such as, without limitation, near, about, approximately, substantially, essentially and the like, mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise.

The terms “proximal” and “distal” simply refer to the opposite ends of a construct and are used as a method of orienting an object with relation to another object such as the orientation of a boss of this invention with respect to the pressure vessel of which it is a part. In general, which end is designated as proximal and which as distal is purely arbitrary unless the context unambiguously expresses otherwise.

As used herein, “contiguous” when referring to two surfaces means that the two surfaces are adjacent and in direct contact with one another or would be in direct contact with one another were it not for an intervening layer of another material such as, without limitation, a gasket, which is itself contiguous to each of the two surfaces.

As used herein, “complementary” or “complementarily” when referring to two objects simply means that the objects are designed and constructed to work together to achieve a particular end. For example, without limitation, if two surfaces are “complementarily threaded” it means that an object comprising one of the threaded surfaces can be screwed into an object comprising the other or complementary threaded surface.

As used herein, the use of “preferred,” “preferably,” or “more preferred,” and the like refers to preferences as they existed at the time of filing of this patent application.

As used herein, a “fluid” refers to a gas, a liquid or a mixture of gas and liquid. For example, without limitation, natural gas as it is extracted from the ground and transported to a processing center is often a mixture of the gas with liquid contaminants. Such mixture would constitute a fluid for the purposes of this invention.

As used herein, a “fluid-tight seal” simply means that a compressed fluid contained in a pressure vessel having such a seal cannot escape the vessel by leaking between contiguous surfaces.

As used herein, a “polymeric composite” has the meaning that would be ascribed to it by those skilled in the art. In brief, it refers to a fibrous or filamentous material that is impregnated with, enveloped by or both impregnated with and enveloped by a polymer matrix material.

As used herein, a “boss” refers to a device as such would be understood by those skilled in the art. In brief, a “boss” is a device used to connect a pressure vessel with external piping through which the pressure vessel is filled with or emptied of a fluid. A “composite boss” simply refers to a boss fabricated of a polymeric composite as described above. A “one-piece” polymeric composite boss refers to a boss that is constructed of a single piece of material such as by, without limitation, an injection molding process.

As used herein, a one-piece weldable metal fitting refers to a construct fabricated of a single piece of metal, which metal is capable of being welded to another piece of metal. Metals capable of being welded include all metals known to those skilled in the welding art and include, without limitation, iron, certain steels and steel alloys, aluminum and copper alloys. In some cases, dissimilar metals may be welded as known the skilled artisan and all such welded connections are within the scope of this invention.

As used herein, a “pressure vessel” refers to an enclosed vessel used for the containment and transport of compressed fluids, such as compressed natural gas, CNG. Pressure vessels presently constitute four regulatory agency approved classes, all of which are cylindrical with one or two domed ends:

Class I. Comprises an all metal, usually aluminum or steel, construct. This type of vessel is inexpensive but is very heavy in relation to the other classes of vessels. Although Type I pressure vessels currently comprise a large portion of the containers used to ship compressed fluids by sea, their use in marine transport incurs very tight economic constraints.

Class II. Comprises a thinner metal cylindrical center section with standard thickness metal end domes in which only the cylindrical portion is reinforced with a composite wrap. The composite wrap generally constitutes glass or carbon filament impregnated with a polymer matrix. The composite is usually “hoop wrapped” around the middle of the vessel. The domes at one or both ends of the vessel are not composite wrapped. In Class II pressure vessels, the metal liner carries about 50% of the stress and the composite carries about 50% of the stress resulting from the internal pressure of the contained compressed fluid. Class II vessels are lighter than Class I vessels but are more expensive.

Class III. Comprises a thin metal liner for the entire structure wherein the liner is reinforced with a filamentous composite wrap around entire vessel. The stress in Type III vessels is shifted virtually entirely to the filamentous material of the composite wrap; the liner need only withstand a small portion of the stress. Type III vessels are much lighter than type I or II vessels but are substantially more expensive.

Class IV. Comprises a polymeric essentially gas-tight liner that is fully wrapped with a filamentous composite. The composite wrap provides the entire strength of the vessel. Type IV vessels are by far the lightest of the four approved classes of pressure vessels but are also the most expensive.

A single-piece composite boss coupled to a weldable metal fitting as set forth herein may be beneficially used with any of the above types of pressure vessels and will dramatically reduce the weight of even a Type I or a Type II pressure vessel while concomitantly provide a coupling mechanism for attachment to external piping delivering a fluid to the pressure vessel that meets the current preferred coupling technique, i.e., welding of the external source to the pressure vessel.

Perhaps most beneficial, however, will be the use of a boss/metal fitting of this invention with either a Type III or a Type IV pressure vessel where its use will even more dramatically reduce the weight of the vessel resulting in a substantial increase in the contained compressed fluid to pressure vessel tare weight ratio and concomitant increase in the value of the contained fluid per unit weight of the vessel. Of course, use of a single-piece composite boss/metal fitting of this invention with pressure vessels of yet undefined types is within the scope of this invention.

As noted above, Type II, III and IV pressure vessel require a composite wrap to give them the necessary strength to withstand the pressure exerted by a compressed fluid contained in the vessel. For a Type II pressure vessel, the wrap is relatively straight-forward and is referred by those skilled in the art as “hoop-wrapping,” which is described elsewhere herein and which is very well-known to those skilled in that art. On the other hand, for Type III and Type IV pressure vessels, to produce a vessel that has the requisite strength it is necessary to wrap the vessel, sometimes in addition to hoop-wrapping, sometimes in lieu of hoop-wrapping, in a manner called “isostensoidal-wrapping,” which is likewise known in the art and is also described elsewhere herein.

When an entire vessel is wrapped with a composite, the underlying metal or polymeric structure is conventionally referred to as a “liner,” which provides the surface on which the composite wrap is wound and which is the surface with which the contained compressed fluid is in direct contact.

For the purpose of this disclosure, only a pressure vessel liner that forms a cylindrical center section with two domed end sections (for the sake of brevity, such vessel will henceforth be referred to simply as a “cylindrical pressure vessel”) and a boss/metal fitting of this invention inserted into a polar opening in one of the domed end sections is described in detail. A boss/metal fitting assembly of this invention would, however, be equally applicable to a spherical, oblate spheroid (near sphere) or toroidal pressure vessel.

Once the boss/fitting is applied to any of these alternate vessel structures, standard techniques for completing the fabrication of the pressure vessel by applying a composite wrap, if necessary, are well-known to those skilled in the art.

Once the cylindrical pressure vessel liner/one-piece composite boss/metal fitting assembly is in hand, while it is hardly a trivial exercise, it is a well-established procedure to design and apply to the liner, including the end domes, a composite comprising a filamentous material and a polymeric matrix, the end result being a completely composite-wrapped pressure vessel. In brief, for a given diameter cylindrical section of a pressure vessel liner, a given polar opening diameter, a given dome shape and a given filament width, a winding pattern can readily be determined using known algorithms including, without limitation, netting analysis, finite element analysis and combinations thereof. Using these mathematical formulae permits the design of a winding pattern that results is an isotensoid wrap of the vessel.

The term “isotensoid” refers to the property of the fully wound vessel in which each filament of the wrap experiences a constant pressure at all points in its path. This is currently considered to be the optimal design for a composite wrapped pressure vessel because, in this configuration, virtually the entire stress imposed on the vessel by a compressed fluid is assumed by the filaments of the composite with very little of the stress being assumed by the polymeric matrix or the liner.

Dome shapes may vary and include, but are not limited to, 2:1 ellipsoidal, 3:1 ellipsoidal and geodesic. The characteristics “2:1” and “3:1” refer to the ratio of the major axis to the minor axis of an ellipse. Presently preferred is a geodesic dome shape since it constitutes a surface of revolution that is amenable to numerical solution for each polar opening diameter, each cylindrical section diameter and each filament width. This numerical solution in turn permits the progressive plotting of the curvature of the dome from the diameter of the pressure vessel toward the polar opening.

Knowledge of the curvature then permits the design and application of a maximum strength, i.e., isotensoid, filament wrap to the vessel using the algorithms mentioned above.

Such pressure vessels exhibit the optimal combination of highest pressure loading at the lightest overall weight.

A composite boss/metal fitting of this invention may be fitted to the polar opening of a vessel liner and the liner may then be wound with a filamentous composite to complete the pressure vessel. The completed pressure vessel can then be coupled to an external source of the fluid with which the vessel is to be loaded by welding the metal fitting to the fluid delivery source, which is virtually invariably at present a metal pipe.

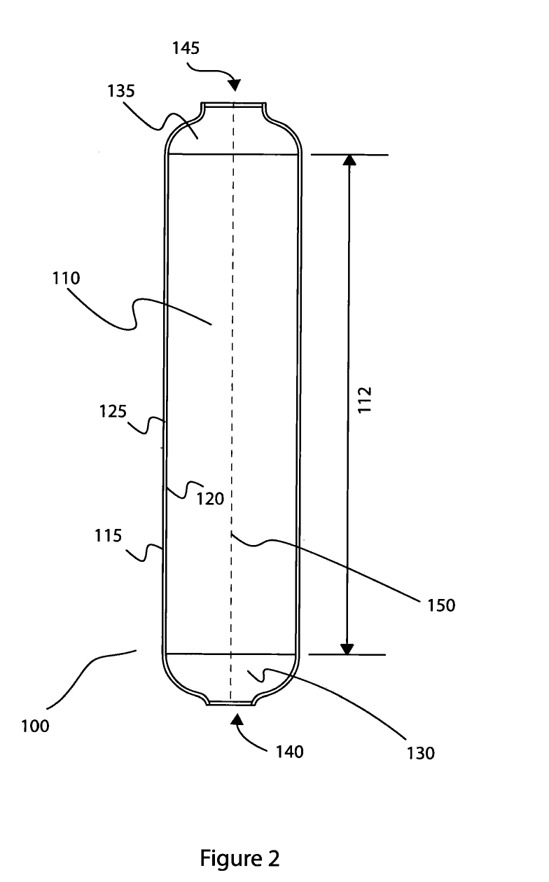

A more detailed schematic of a pressure vessel liner is shown in FIG. 2. As mentioned previously, the composite overwrap, while constituting relatively sophisticated design mathematics and implementation machinery, is well-known to those skilled in the pressure vessel design and fabrication art and any of these known techniques can be applied to a pressure vessel liner comprising a composite boss/metal fitting of this invention. Thus, except where aspects of composite-wrapping are relevant to elements of this invention, in which case they will be fully discussed, the design and implementation of composite vessel wraps will not be further discussed.

Pressure vessel liner 100 shown in FIG. 2 is comprised of cylindrical center section 110 having length 112, outer surface 115, inner surface 120, thickness 125, domes 130 and 135 and polar openings 140 and 145.

As mentioned previously, it is possible and is within the scope of this invention that a pressure vessel of this invention may comprise a polar opening in only one of domes 130 and 135.

The domes as shown are rounded to blend from the cylinder, through the shoulders and up to the neck. They can also assume other curved shapes, including generally hemi-spherical shapes. With such hemi-spherical shapes in particular, it is noted that, as the length 112 of cylindrical section 110 approaches zero, the result is a substantially spherical or oblate spheroidal pressure vessel. This merely reinforces the previous statement that the composite boss/metal fitting of this invention is equally suited to a spherical or oblate spheroidal pressure vessel as it is to a cylindrical pressure vessel.

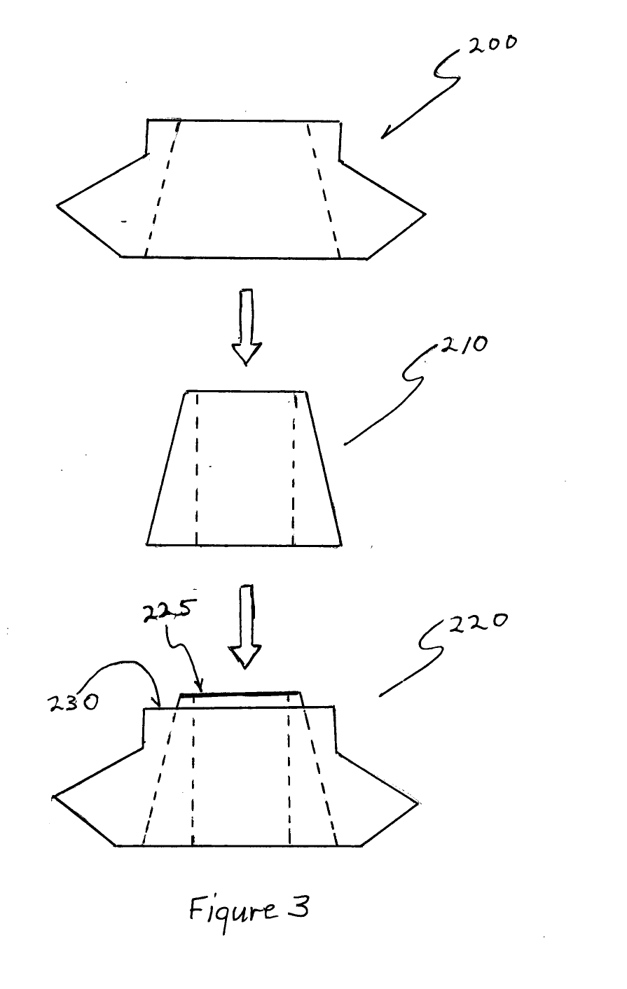

FIG. 3 shows one-piece polymeric composite boss 200, one-piece weldable metal fitting 210 and assembly 220 comprising metal fitting 210 inserted into composite boss 200. Portion 225 of metal fitting 2210 extends outward from proximal end 230 of boss 200 to more readily permit welding of fitting 210 to an external source of compressed fluid.

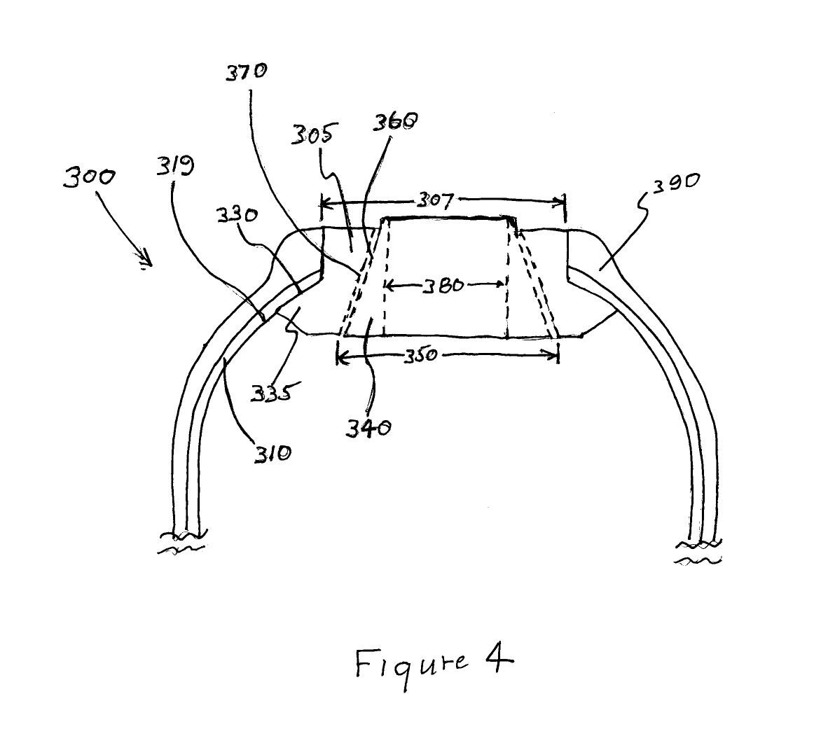

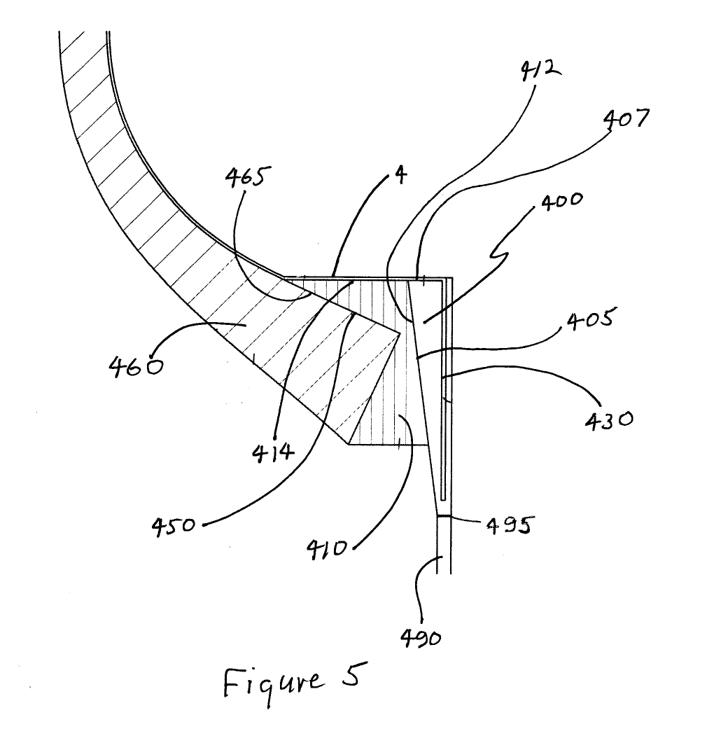

FIG. 4 shows an end section 300 of a pressure vessel with single piece polymeric composite boss 305 inserted into polar opening 307. Surface 330 of flange 335 is contiguous with inner surface 319 of liner 310. Metal fitting 340 is inserted into lumen 350 of boss 305 such that outer surface 360 of metal fitting 340 is contiguous with the inner surface 370 of lumen 350. If desired, a conical-shaped gasket (not shown) can be inserted between inner surface 370 of lumen 350 and outer surface 360 of metal fitting 340 such that, when pressure is applied by the compressed fluid in the pressure vessel outer surface 360 is pressed outward and compresses the gasket against inner surface 370 of lumen 350 thereby forming a fluid-tight seal. Weldable metal fitting 340 further comprises lumen 380 to provide a fluid connection between the interior of the pressure vessel and the external source of compressed fluid. The entire pressure vessel may be hoop, isotensoidally or both hoop and isotensiodally wrapped as needed with a layer 390 of filamentous material to complete the pressure vessel.

A one-piece composite boss of this invention comprises a polymeric matrix containing fibrous materials that confer additional strength on the composite. The polymeric matrix can be any polymer known or found to have properties consistent with use in a high pressure environment such as that found in a pressure vessel of this invention.

While thermoplastic polymers, thermoplastic elastomers, thermoset resins and combinations thereof can be used, presently preferred are thermoset polymers, which can exhibit significantly better mechanical properties, chemical resistance, thermal stability and overall durability than the other types of polymers.

A particular advantage of most thermoset plastics or resins is that their precursor monomers or prepolymers tend to have relatively low viscosities under ambient conditions of pressure and temperature and therefore can be introduced into or combined with fibers and filaments quite easily.

Another advantage is that thermoset polymers can usually be chemically cured isothermally, that is, at the same temperature at which they are combined with the fibers/filaments, which can be room temperature.

Suitable thermoset resins include, without limitation, epoxy resins, polyester resins, vinyl ester resins, polyimides, dicyclopentadiene resins and combinations thereof.

Presently preferred are dicyclopentadiene resins, in particular ROMP-synthesized cyclopentadiene resins.

In general, any type of fibrous or filamentous material may be used to create the polymeric composites of this invention. Such materials include, without limitation, natural (silk, hemp, flax, etc.), metal, ceramic, basalt and synthetic polymer fibers and filaments.

Presently preferred materials include glass fibers, commonly known as fiberglass, carbon fibers, aramid fibers, which go mostly notably under the trade name Kevlar® and ultra-high molecular weight polyethylene, such as Spectra® (Honeywell Corporation) and Dyneeva® (Royal DSM N.V.).

As shown in FIG. 4, a pressure vessel may comprise a vessel liner. A pressure vessel liner may comprise a single layer of material or multiple layers. For example, without limitation, the vessel liner may comprise a single metal layer such as, without limitation, stainless, steel, zinc, copper, tin, aluminum and combinations and alloys thereof, in which case the liner would be a Type III pressure vessel.

Alternatively the liner may comprise a single layer or multiple layers of polymer, wherein each layer may be the same as or different than each other layer, which would constitute a Type IV pressure vessel.

A pressure vessel liner may alternatively comprise a polymeric layer having on its inner surface, the surface in contact with the contained gas, a very thin layer of metal to assist with the impermeability, imperviousness or both impermeability and imperviousness, or impentetrability, of the vessel to a contained fluid. This would still comprise a Type IV pressure vessel since the metal layer would be too thin to constitute a structural feature of the liner.

A composite boss/metal fitting construct of this invention may consist of a portion of the composite boss such as flange 335 in FIG. 4 being contiguous to a portion of a liner, i.e., surface 330 of boss 305 being contiguous to surface 319 of liner 310. The flange is pressed against the liner when the vessel is pressurized and thereby keeps the composite boss in place against the internal pressure exerted by a contained compressed fluid. As an alternative, however, it is possible to have the liner contiguous to a non-load-bearing surface of the boss and have an end of the liner insert into a liner channel in the metal construct. Such a construct is shown in FIG. 5. In FIG. 5, metal fitting 400 is inserted into composite boss 410 such that surface 405 of metal fitting 400 is contiguous to surface 412 of boss 410. Vessel liner 420 is then placed contiguous to surface 414 of boss 410 and surface 407 of metal fitting 400 and is then inserted into liner channel 430 in metal fitting 400. In this manner, the liner forms a fluid-tight seal and eliminates the need for a separate gasket between the boss and the metal construct to create the seal. When composite over-wrap 460 is applied to the pressure vessel, load-bearing surface 450 of boss 410 becomes contiguous surface 465 of over-wrap 460 thereby assuring the continuity of the pressure vessel when an internal pressure is exerted by a contained fluid. FIG. 5 also shows external fluid source 490 welded at weld 495 to metal fitting 400.

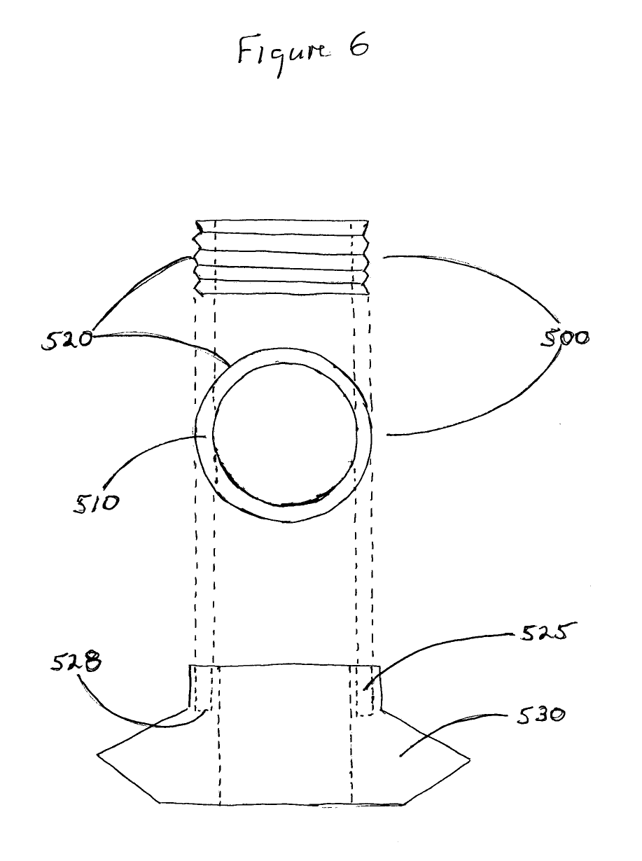

Another embodiment of this invention comprises the assembly shown in FIG. 6. In FIG. 6, metal fitting 500 comprises annular ring 510 with threaded outer surface 520. Groove 525 of boss 530 is threaded in a complementary manner such that fitting 500 can be screwed into boss 530. While the screw fitting itself may be tight enough to assure a fluid-tight seal, it is possible to insert a gasket (not shown) into groove 525 such that when fitting 500 is screwed down into groove 525 the gasket is compressed against bottom surface 528 of groove 525 thereby forming a fluid-tight seal.

A boss of this invention can be coupled with a vessel liner in several ways. If the vessel liner is polymeric, the complete liner, including the dome with polar opening, can be shaped on a mandrel. Once formed, the liner, while the polymer is still hot enough to be flexible or, if upon reheating it can again achieve a state of flexibility, can be mechanically expanded at the polar opening sufficiently to permit the flared flange at the distal end of the boss to pass through. With the boss in place, the polar opening liner can be allowed to return to its initial dimension and then the entire vessel liner can be cooled to set the boss in place. The result is shown in FIG. 4, where a portion of outer surface 318 of boss 305 can be seen to be contiguous with thickness 318 of liner 300 at the diameter of polar opening 305.

In this embodiment, the composite boss will be in contact with whatever material, gas and/or liquid, that is contained in the pressure vessel.

In another embodiment, the boss itself can be affixed to a mandrel where it becomes part of the template that is used to form the vessel liner. The vessel liner is then formed over the entire template including the boss. As above, the composite boss will be in direct contact with whatever is contained in the pressure vessel.

In all of the above cases, the weldable fitting can be assembled with the composite boss subsequent to the formation of the boss.

If a Type III vessel is contemplated, the boss/weldable fitting may be fitted into the polar opening as the sheets of metal are being bent and joined to form the pressure vessel.

Other methods for coupling a composite boss/weldable fitting of this invention with a liner may occur to those skilled in the art; all such methods are within the scope of this invention.

Once the vessel liner has been formed and the boss is in place using one of the techniques discussed above, the liner can be wound with a filamentous composite to produce the complete pressure vessel.

A fully-formed Type III or Type IV pressure vessel comprising a composite boss/weldable fitting of this invention is within the scope hereof.

A pressure vessel comprising a boss/fitting of this invention can be used to contain and transport any type of fluid that is amenable to such transport and so long as the vessel or vessel liner, if present, be it metal, ceramic or polymer, is selected so as to be impermeable or impenetrable to the contained compressed fluid, and chemically inert thereto as well.

A presently preferred use of a composite boss/weldable fitting-containing pressure vessel of this invention is for the containment and transport of natural gas, often referred to as “compressed natural gas” or simply “CNG.”

CNG may be contained and transported in the vessels of this invention both as a purified gas and as “raw gas.” Raw gas refers to natural gas as it comes, unprocessed, directly from the well. It contains, of course, the natural gas (methane) itself but also may contain liquids such as condensate, natural gasoline and liquefied petroleum gas. Water may also be present as may other gases, either in the gaseous state or dissolved in the water, such as nitrogen, carbon dioxide, hydrogen sulfide and helium. Some of these may be reactive in their own right or may be reactive when dissolved in water, such as carbon dioxide and hydrogen sulfide which produces an acid when dissolved in water.

The presently preferred liner polymer, dicyclopentadiene, has excellent properties with regard to chemical resistance to the above, and other materials that might constitute raw gas.

High density polyethylene also works well with raw gas.

Other liner materials that are impervious to raw gas components will readily be discernable based on the disclosures herein and pressure vessels having composite bosses of this invention together with any type of vessel or vessel liner composition are within the scope of this invention.

The present invention has therefore been described above purely by way of example. Modifications in detail may be made to the invention within the scope of the claims appended hereto.

What is claimed:

1. A pressure vessel comprising:
a one-piece polymeric composite boss; and
a one-piece weldable metal fitting coupled to the one-piece polymeric composite boss.

2. The pressure vessel of claim 1, wherein:
the one-piece polymeric composite boss comprises a proximal end that is external to the pressure vessel; a distal end that is internal to the pressure vessel; an inner surface that describes a central lumen in the shape of a truncated cone with its base at the distal end of the boss and its truncated apex at the proximal end of the boss; and
the one-piece weldable metal fitting comprises an outer surface that describes a truncated cone that is complementary to the truncated cone-shaped central lumen such that when the metal fitting is inserted into the lumen, the outer surface of the metal fitting is contiguous to the inner surface of the boss.

3. The pressure vessel of claim 2, comprising a gasket shaped like a truncated cone, an outer surface of which is contiguous to the inner surface of the one-piece composite boss and an inner surface of which is contiguous to the outer surface of the one-piece metal fitting when the gasket is interposed between the inner surface of the one-piece composite boss and the outer surface of the metal fitting.

4. The pressure vessel of claim 2, wherein a length of the proximal end of the metal fitting extends outward from the proximal end of the composite boss.

5. The pressure vessel of claim 2, wherein the metal fitting further comprises a central cylindrical lumen.

6. The pressure vessel of claim 2, wherein the metal fitting further comprises a liner channel for receiving a portion of a pressure vessel liner.

7. The pressure vessel of claim 1, wherein a proximal end of the one-piece composite boss comprises an inset threaded groove and the one-piece metal fitting comprises a complementarily threaded annular ring that can be screwed into the threaded groove to couple the metal fitting to the boss.

8. The pressure vessel of claim 7, comprising a gasket that is fitted into the threaded groove of the composite boss such that an end of the threaded metal fitting contacts and compresses the gasket when the threaded metal fitting is tightened down into the threaded groove of the composite boss thereby forming a gas-tight seal.
